(19) United States
(12) Patent Application Publication
(10) Pub. No.: US 2022/0018117 A1
(43) Pub. Date: Jan. 20, 2022

(54) JIMMY TWIST WRENCH WITH SHAFT AND HANDLE APPARATUS AND A METHOD OF USING SAME

(71) Applicant: Mario David Bertorelli, New Windsor, NY (US)

(72) Inventor: Mario David Bertorelli, New Windsor, NY (US)

(21) Appl. No.: 17/378,420

(22) Filed: Jul. 16, 2021

Related U.S. Application Data
(60) Provisional application No. 63/053,566, filed on Jul. 17, 2020.

(51) Int. Cl. E04B 1/48; E01C 23/04; B25B 23/16; B25B 13/50

(52) U.S. Cl. CPC E04B 1/483; B25B 13/5041; B25B 23/16; E01C 23/04

(57) ABSTRACT

The present invention relates to an adjustable wrench with shaft and turn handle apparatus and a method of using same. The invention encompasses a Jimmy Twist which is an inventive apparatus comprising an adjustable wrench at one end of a shaft, a turn handle at the opposite end, and a method of using same. The turn handle, stop, eyelet, and wrench are all adjustable, while the turn handle is capable of rotating the attached shaft. The tool can be used to screw a rod, such as, a threaded iron rod, into its desired location, such as, into a coupler. The inventive Jimmy Twist allows the easy screwing of a DBS (Dowel Bar Substitute) into a coupler. The Jimmy Twist is very quick and easy to use, and is lightweight. The Jimmy Twist also has at least one eyelet to stabilize the rod that is being screwed.

### CROSS-REFERENCE TO RELATED APPLICATION

The instant patent application claims priority to and the benefit of pending U.S. Provisional Patent Application Ser. No. 63/053,566, filed on Jul. 17, 2020, titled “The Jimmy Twist,” the entire disclosure of which provisional application is incorporated herein by reference.

### FIELD OF THE INVENTION

The present invention relates to an adjustable wrench with shaft and turn handle apparatus and a method of using same. The invention encompasses a Jimmy Twist which is an inventive apparatus comprising an adjustable wrench at one end of a shaft, a turn handle at the opposite end, and a method of using same. The turn handle, stop, eyelet, and wrench are all adjustable, while the turn handle is capable of rotating the attached shaft. The tool can be used to screw a rod, such as, a threaded iron rod, into its desired location, such as, into a coupler. The inventive Jimmy Twist allows the easy screwing of a DBS (Dowel Bar Substitute) into a coupler. The Jimmy Twist is very quick and easy to use, and is lightweight. The Jimmy Twist also has at least one eyelet to stabilize the rod that is being screwed.

### BACKGROUND INFORMATION

Dowel Bar Substitute (DBS) or Dowel Bar Replacements (DBR) have been used in the construction industry for many years, and are typically specified to provide continuity and structural integrity in segmental concrete pour applications for reinforced concrete construction. The coupler/bar assembly is provided with an attached mounting plate. The assembly is, in turn, nailed or secured to the formwork. Once the form is set the externally threaded rebar is screwed into the exposed end of the coupler, creating a mechanical butt splice of two sections of reinforcing steel, and where the Dowel Bar Substitute (DBS) is normally rotated about four revolutions to securely mate at the mounting plate of the coupler.

Dowel Bars are typically round steel bars which are used for providing a mechanical connection between slabs without restricting horizontal joint movement. These dowel bars have many applications, such as, for example, they are used in the jointed plain concrete pavement for carrying the added load and stress which are induced because, for example, due to the movement of vehicles. Although, the dowel bars are round steel bars, they are reinforced with a round deformation (rebar), especially for concrete applications. Additionally, in reinforced concrete pavements, dowel bars are typically used to transfer the load across the transverse joint from one pavement slab into the adjoining slab.

U.S. Pat. No. 4,812,088 (Leon M. Hake), the entire disclosure of which is incorporated herein by reference, discloses a doweling tool for drilling a dowel hole in concrete to facilitate the insertion of dowels, the doweling tool having a guide bar, a support frame for supporting the tmide bar, a carriaue movingly connected to the guide bar, a pneumatically operated drilling tool having a drill bit connected to the carriage and a pneumatic cylinder having a portion connected to the support frame and another portion connected to the carriage. The pneumatic cylinder is operable to move the carriage and the drilling tool connected thereto in a forward direction for drilling the dowel hole and for moving the carriage and the drilling tool connected thereto in a reverse direction for withdrawing the drilling tool from the dowel hole. The carriage is rollingly supported on the guide bar by a roller assemblies for rolling movement in the forward and reverse direction.

U.S. Pat. No. 6,502,359 (Todd Rambo), the entire disclosure of which is incorporated herein by reference, discloses an expendable concrete dowel placement apparatus comprising a concrete form and a dowel holder capable of quickly positioning a dowel perpendicular to the surface of the concrete form, thereby allowing the finished concrete slab to expand and contract relative to a control joint without the dowel causing the concrete to yield. The concrete form maintains a plurality of square or rectangular apertures which receive the dowel bar holders. Each dowel bar holder maintains a plurality of retention clips and a located at its open proximal end which positively positions the dowel bar holder within the apertures of the concrete form in a position perpendicular to the front surface of the central vertical member of the concrete form. The concrete form is composed of a non-typical shape which allows the control joint to transfer loads to adjoining concrete slabs through the length of the control joint. Additionally, loads are transferred to adjoining slabs by the dowel or plurality of dowels located within the concrete slab.

The Lenton Taper Threaded Rebar Splicing Systems (2008), the entire disclosure of which is incorporated herein by reference, discloses various couplers currently in use in the concrete construction industry, such as, for example, a standard coupler, a transition coupler, a position coupler, a bolt coupler, a weldable coupler, a terminator, to name a few.

The Rebar Splicing Handbook for concrete construction products by Dayton Superior (Rev. 6/2020), the entire disclosure of which is incorporated herein by reference, discloses various threaded splicing systems, bar locks, taper locks, sleeve locks, end anchorage, etc., which are currently in use in the concrete construction industry.

This invention improves on the deficiencies of the prior art and provides an inventive tool having a shaft with at least one adjustable wrench at one end of the shaft, and at least one handle at the other or opposite end, and a method of using same.

### PURPOSES AND SUMMARY OF THE INVENTION

The invention is a novel inventive tool having a shaft with at least one adjustable wrench at one end of the shaft, and at least one handle at the other or opposite end, and a method of using same.

Therefore, one purpose of this invention is to provide an inventive tool having a shaft with at least one adjustable wrench at one end of the shaft, and at least one handle at the other or opposite end, and a method of using same.

Another purpose of this invention is to provide an inventive Jimmy Twist tool that is designed to quickly and efficiently install DBS (Dowel Bar Substitute) into a coupler.

Yet another purpose of this invention is to provide a turn handle, a rod stop, a rod eyelet, and a wrench which are all adjustable, and wherein the turn handle is capable of rotating the attached shaft along with the wrench.

Still yet another purpose of this invention is to provide stability, and torque assistance during the insertion of the bar or rod into the coupler.

Therefore, in one aspect this invention comprises an apparatus, comprising:
(a) a turn shaft having a first end, and a second end;
(b) a turn handle in secure, and engaging contact with said turn shaft at said first end;
(c) an adjustable pipe wrench in secure, and engaging contact with said turn shaft at said second end; and
(d) a stop in secure contact with said turn shaft between said first end, and said end.

In another aspect this invention comprises a method of securing a rod to a coupler, comprising the steps of:
(a) taking a turning tool, wherein said turning tool has a turn shaft having a first end, and a second end, and wherein said first end has a turn handle, and said second end has an adjustable pipe wrench, and a stop between said first end, and said end;
(b) taking a threaded rod having a first end and a second end, and removably engaging said first end against said stop on said turn shaft;
(c) removably securing a portion of said second end of said rod inside a jaw of said adjustable pipe wrench;
(d) engaging a threaded portion of said rod with a threaded opening in said coupler, and turning said turn handle to screw said threaded portion of said threaded rod into said threaded portion of said coupler.

### BRIEF DESCRIPTION OF THE DRAWINGS

FIG. 1, illustrates a standard double threaded rebar or dowel rod or splice bar having external threads at both ends or the rebar.

FIG. 2, illustrates a standard single threaded rebar or dowel rod or splice bar having external threads at one end, and which end is used to secure the threaded rebar to a standard rebar coupler.

FIG. 3, illustrates a standard threaded rebar coupler that has secured thereto a splice or a standard threaded rebar or dowel rod.

FIG. 4, illustrates a first embodiment of the inventive tool or apparatus, namely, The Jimmy Twist.

FIG. 5, illustrates a second embodiment of the inventive tool or apparatus, namely, The Jimmy Twist.

FIG. 6, illustrates a third embodiment of the inventive tool or apparatus, namely, The Jimmy Twist, showing a top view of a variety of turn handles that can be used with the inventive tool.

FIG. 7, illustrates a fourth embodiment of the inventive tool or apparatus, namely, The Jimmy Twist, as being used to install a rebar, into a coupler that has already been secured to concrete.

FIG. 8, illustrates various cross-sectional shapes that can be used for the various component of the inventive tool or apparatus, namely, The Jimmy Twist.

FIG. 9, illustrates a fifth embodiment of the inventive tool or apparatus, namely, The Jimmy Twist.

FIG. 10, illustrates a sixth embodiment of the inventive tool or apparatus, namely, The Jimmy Twist.

FIG. 11, illustrates a seventh embodiment of the inventive tool or apparatus, namely, The Jimmy Twist.

FIG. 12, illustrates another embodiment of a coupler that can be used with the inventive tool or apparatus, namely, The Jimmy Twist.

FIG. 13, illustrates an eight embodiment of the inventive tool or apparatus, namely, The Jimmy Twist, illustrating another embodiment of an eyelet, that can be used with the inventive tool or apparatus.

FIG. 14, illustrates a ninth embodiment of the inventive tool or apparatus, namely, The Jimmy Twist, illustrating another embodiment of an inventive adjustable pipe wrench that can be used with the inventive tool or apparatus.

### DETAILED DESCRIPTION

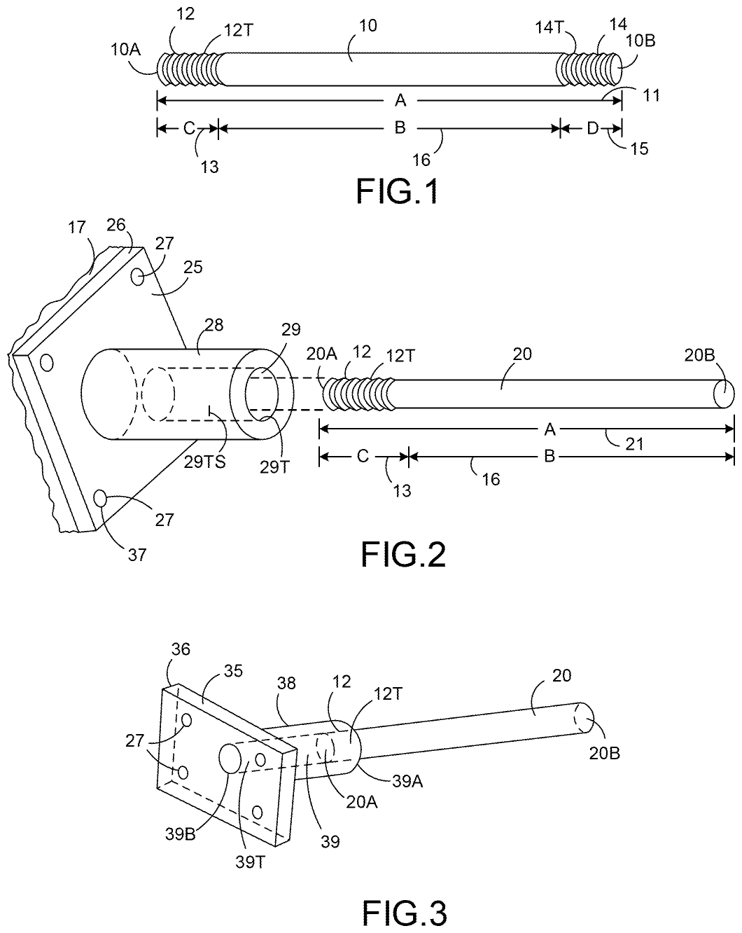

The inventive tool having a shaft with at least one adjustable wrench at one end of the shaft, and at least one handle at the other or opposite end of the shaft, and a method of using same will now be discussed with reference to FIGS. 1 through 14. Although the scope of the present invention is much broader than any particular embodiment, a detailed description of the preferred embodiment follows together with drawings. These drawings are for illustration purposes only and are not drawn to scale. Like numbers represent like features and components in the drawings.

The invention, namely, “The Jimmy Twist”, is an inventive tool that can be used to screw a rod, such as, for example, a threaded iron rod, into its desired location, such as, into a coupler.

The inventive Jimmy Twist screws the DBS (Dowel Bar Substitute) into a coupler with ease. The Jimmy Twist is very easy, and quick to use, and is also very lightweight.

The inventive Jimmy Twist saves an incredible amount of man hours when it is used to screws the DBS (Dowel Bar Substitute) into a coupler, while also saving the “backs” of the Reinforcing Ironworker, who has to manually screw the DBS (Dowel Bar Substitute) into a coupler, as in the past a standard adjustable pipe wrench was used, which did not easily grab the dowel rod, or would slip off the dowel rod, and which also did not provide any stability or torque assistance.

In summary a DBS rod goes through an eyelet in the Jimmy Twist, which allows for the top of the bar or rod to sit or rest at a stop. Then in a swinging motion using the handle, such as, a T-handle, an adjustable pipe wrench is used to catches the DBS a little above the DBS thread, such as, for example, say about 1 inch to about 2 inches above the DBS threads. The eyelet in the Jimmy Twist stabilizes the DBS bar, and so the Jimmy Twist tightens the DBS bar with ease. Similarly, in a reverse motion or swing The Jimmy Twist will unscrew or unlatch quickly from the DBS bar, and is now ready to be used on the next or second DBS bar or dowel rod.

The inventive Jimmy Twist, is a tool that is designed to quickly and efficiently install DBS (Dowel Bar Substitute). A DBS is a piece of rebar with threads at one end that gets screwed into a coupler, which had been installed earlier.

Traditionally, the Reinforcing Ironworker will remove a plastic cap from the coupler (the plastic cap keeps the coupler hole clean during the pouring of the concrete at the construction site), and then the operator starts screwing the DBS rod or bar into the coupler by hand, and then uses a standard pipe wrench to tighten it. So essentially this is a three-step process, namely, in step one, the user or operator would clear the coupler hole by removing the plastic cap, and then start to thread the rebar into the coupler using his hands. In step two, the operator would tighten the threaded rebar with a standard pipe wrench, and then in step three, the operator would torque the threaded rebar with a torque wrench to the desired or defined torque. Additionally, during the installation the standard pipe wrench has to be adjusted multiple times to achieve the desired torque with the torque wrench to a specified torque, such as, for example: a Number 6 torque or % inch torque, or that the DBS bar has to be torqued to, say, about 130 pounds per foot, etc.

With the inventive Jimmy Twist, one can easily cut out the three steps from the traditional process as discussed earlier. The inventive Jimmy Twist is a quick on, quick off tool allowing for a full rotation of the DBS bar or rod in open spaces, or partial rotation in tight areas. The inventive Jimmy Twist cuts out the back breaking task of tightening, and torquing vertical DBS bar or rod while also cutting out almost two thirds of the time, if not more, to install the DBS bar or rod. This is due to the fact that the Reinforcing Ironworker does not need to bend over during the tightening of the DBS bar or rod, and this also saves him time and energy, and thus allowing the Reinforcing Ironworker to install more DBS bars or rods, compared to a Reinforcing Ironworker who is first using his hands, and then is using just a standard pipe wrench to fully, and properly tighten the DBS bar or rod.

The inventive Jimmy Twist, basically comprises of a tool comprising of at least one turn handle, such as, for example, a T-handle, but the at least one turn handle could also be a L-shaped handle, a U-shaped handle, a wheel shaped handle, and combinations thereof, to name a few. Also, the turn handle can be fixed on the inventive tool, or the turn handle can be attachable, and adjustable. At the bottom of the turn shaft there would be at least one bracket to securely attach the pipe wrench. For some applications, the adjustable pipe wrench can be fixed, or bolted on, or welded, etc., onto the shaft of the inventive Jimmy Twist. The inventive Jimmy Twist is able to accommodate a #3 DBS, through a #11 DBS that are normally about two (2) feet long to about four (4) feet long.

The inventive Jimmy Twist device is not limited to just a pipe wrench head, but of any apparatus that is used to successfully grasp rebar, turn rebar, and quickly release a rebar. Attachments, such as, different size eyelets, and different size stops, comprising of any material suitable for task can also be used. Other attachments can also be fabricated to screw pre-bent steel, such as, pre-bent right angles, and pre-bent hooks, etc. The turn handle can also comprise of at least one ratcheting mechanism for less readjusting. The turn handle that is used for ratcheting can comprise of any shape, and material that is suitable for the job. For some applications a torque ratchet mechanism can also be used as an option.

The adjustable wrench head can be secured, such as, by welding, using nut and bolt, or any quick release system, like for example, a quick release bolt. The inventive Jimmy Twist can be made to go in one direction (tightening), but also can be made to go bidirectional because mistakes are sometimes made, whether it is by the Reinforcing Ironworker, or a faulty coupler causing trouble, etc. The inventive Jimmy Twist makeup could also consist of pipe or cylinder comprising of any material where a notch is cut out and a gripping apparatus, such as, such as, a pipe wrench, is securely fixed. The inventive Jimmy Twist with its wrench grips the DBS bar for a smooth and an easy twist.

One could also use a device that would have any type of a turn handle which is suitable for task, and could easily slip over the DBS to be secured to the coupler. The pipe or cylinder would stabilize the DBS, while offering a smooth, and easy twist. The turn handle for the inventive Jimmy Twist could be fixed, or detachable or adjustable. The turn handle could also be fitted with a drive socket. This drive socket would have to be centered over, or “plumb”, over the top of the DBS. This will allow for a smooth turn when using drive socket with drill, ratchet wrench, or any apparatus designed to turn a socket drive. The drive socket fixture could include, but is not limited to, the traditional square design, but to any shape, and any size drive system. The inventive Jimmy Twist could also have an attachment that fits an electric pipe threader, a special die adapter for the bigger bars when other methods or tools are not available. It should be understood that the attachment are not limited to just fit electric pipe threader but all types of pipe threaders, manual or electric.

For some applications the pipe threader, could be for example, of an octagon shaped “puck” with a square or any shaped drive hole that slides over top of the matching male drive on The Jimmy Twist which would allow the pipe threader to work as needed.

Currently there are several types of couplers that are in use in the concrete construction industry, such as, for example, a coupler with parallel threads, where threads can be cut, rolled or forged. There are two variations to this type of coupler. The first one uses reinforcing bars with the threaded portion having a smaller diameter than the rest, and a second type which uses bars with the threaded portion having a cross sectional area equal or greater than the nominal size. The first type is rarely used since the load capacity is reduced, while the second type maintains the parent bar load capacity and is widely used. An alternative to the first type also includes a variant where one end of a parallel threaded coupler is swaged onto a bar. The parallel or the first type coupler also has transitional and positional variants. The transitional coupler allows two bars of different sizes to be joined. While the positional coupler usually comprises two halves joined by a parallel thread with a lock nut arrangement.

Another coupler system includes couplers with taper-cut threads, which basically consists of an internally threaded metal coupler with a tapered thread, and a matching tapered bar. Due to its ability to meet the majority of the structural building applications it is popular. The standard tapered coupler can only be used in situations where the continuing bars can be rotated. This is not always practical and more sophisticated tapered couplers have been developed which allow the joining of bars that cannot be rotated, and the joining of bars where the continuing bar can neither be rotated nor moved (e.g. L-shaped bars).

Another system comprises of couplers with integral threads over full length bar. These high yield reinforcing bars are specially manufactured with helical deformations along the full length of the bar. The deformations form a continuous coarse thread onto which an internally threaded coupler can be screwed. Locknuts are used at either end of the coupler to prevent slippage on the coarse threads. A turnbuckle system for when the continuing bar cannot be rotated is not available, but the coupler can be completely threaded onto one bar and then run back onto the continuing bar to form the joint.

Another threaded coupler system uses swaging onto the ends of reinforcing bars. In this system two malleable sleeves which are threaded internally for half their length are joined together by a high tensile threaded stud. The unthreaded parts of the sleeves are hydraulically swaged on the two ends of the bar to be joined. These ends can be screwed together using the threaded stud. The swaging process can be performed by the fabricator prior to arrival on site, in a stockyard at the site, or in-situ. For the latter method it must be ensured that there is sufficient working space around the bars. Connection of the bars with the threaded stud is performed in-situ.

Another coupler system uses standard couplers which are designed to splice the same diameter bars where one bar can be rotated, and the bar is not restricted in its axial direction.

The transition couplers are designed to splice different diameter bars where one bar can be rotated, and the bar is not restricted in its axial direction.

Another type of coupler are the bolt couplers which provide a full-strength joint between a reinforcing bar and a standard metric bolt. The bolt coupler may be used for load-carrying steel structures bolted to concrete foundations, columns or walls, such as pylon bases, fixing crane rails, and fixings for heavy pipe work and walkways. These bolt couplers are machined from non-weldable grades of material but can be tack welded. They can make a convenient transition from reinforcing bar to metric threaded stud, maintaining the full strength of the bar. Transition is useful when forming long tie-bars, such as in formwork or pile-planks, against internal pressure, and to form a restraint anchor for ground anchors.

The terminator coupler provides an alternative to hooked rebar, or an anchor or stop nut for rebar passing through a pile plank or structural steel element. The front face of the coupler is generously designed to carry the full tension load of the rebar when the anchor is bearing against concrete or structural steel.

The transition rebar coupler is used to join two reinforcing bars of different sizes. It is commonly used for economic designs and columns where the diameter of the rebar reduces as the columns extend up the structure.

FIG. 1, illustrates a standard double threaded rebar or dowel rod or splice bar 10, having end threads 12, 14, at both ends of the rebar 10. In the construction industry one of the two end threads 12, 14, having external threads 12T, 14T, respectively, is used to secure the double threaded rebar 10, to the standard rebar coupler or flange coupler 25, 35, 125, as more clearly shown in FIGS. 2, 3, and 12. The double threaded rebar 10, has an external length A 11, a splice portion B 16, a first external threaded length portion C 13, at one or first end 12, and a second external threaded length portion D 15, at the opposite or second end 14, of the double threaded rebar 10. It should be appreciated that the first external threaded length portion C 13, could have the same external threaded dimensions 12T, as the second or opposite external threaded length portion D 15, or the external threaded dimensions 12T, could be different, both in length, and diameter. The double threaded rebar 10, has a first or one end surface 10A, and an opposite or second end surface 10B. The end surfaces 10A, 10B, are typically substantially flat. Additionally, the first end thread 12, thread length C 13, could be the same as or different then the second end thread 14, thread length D 15, and similarly the diameter of the external thread 12T, could be the same or different than the external thread 14T.

FIG. 2, illustrates a standard single threaded rebar or dowel rod or splice bar 20, having a first end 20A, and a second end 20B, and where the first end 20A, has end threads 12, having external threads 12T, and which end 20A, is used to secure the threaded rebar 20, to a standard rebar coupler or flange coupler 25. The single threaded rebar 20, has an external length A 21, a splice portion B 16, and an external threaded length portion C 13. The splice bars 10, 20, are made from standard rebar material, and are available in all of the corresponding sizes to the threaded rebar coupler 25, 35, 125, as illustrated in FIGS. 2, 3, and 12. After the setting coupler 25, 35, has been placed, and the concrete 17, has set, the splice bar 10, 20, is threaded into the coupler or flange coupler 25, 35, to complete the splice. The splice bars 10, 20, are available in many configurations, such as, a straight splice bar 10, 20, with external threads 12T, at one thread end 12, or external threads 12T, 14T, at each thread ends 12, 14. The standard threaded rebar or rods 10, 20, are normally about two (2) feet long to about four (4) feet long, and thus a worker or installer (not shown) has to go down to their knee level or bend down to install a rebar or rod 10, 20, that is normally between about two (2) feet long to about four (4) feet long. FIG. 2, further illustrates a standard threaded rebar coupler 25, having a flange base 26, where the rebar coupler or flange coupler 25, has a coupler pipe or tube 28, that is either welded or integrated with the flange base 26. The flange base 26, has a plurality of holes or openings 27, for the passage of a securing means 37, such as, a nail 37, a concrete nail 37, a screw 37, and combinations thereof, to name a few, that are used to secure the flange coupler 25, 35, to the site 17, such as, a concrete site 17. The coupler pipe 28, has a hole or opening 29, having internal threads 29T, to accommodate the external threads 12T, 14T, of a splice bar or rod or DBS 10, 20. Threaded Rebar Coupler or flange coupler 25, 35, 125, is available in many rebar sizes, such as, from #3 to #11. For some applications the coupler pipe 28, could have at least one internal positive thread stop 29TS. FIG. 2, illustrates an internally threaded rebar coupler or flange coupler 25, with a coupler pipe 28, having a blind hole or opening 29.

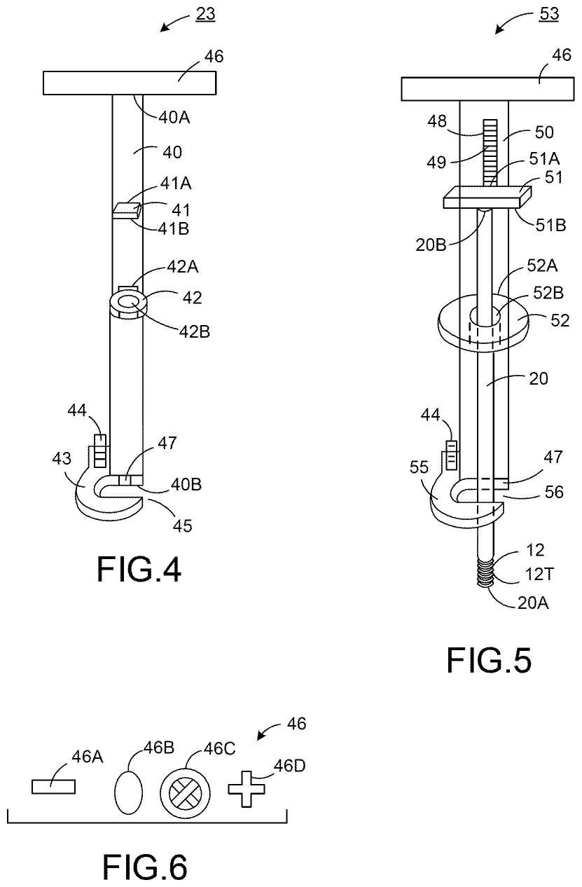

FIG. 3, illustrates a standard threaded rebar coupler 35, having a base 36, a coupler pipe 38, with opening or hole 39, and a plurality of holes or openings 27, in the base 36, that has secured thereto a splice or a standard threaded rebar or dowel rod 10, 20. The threaded end 12, of the standard threaded rebar 20, is inserted into the hole or opening 39, of the standard threaded rebar coupler or flange coupler 35, such that the external threads 12T, 14T, of the threaded rebar 10, 20, mate, and removeably, and engageably contact with the internal threads 39T, of the coupler pipe 38. Currently, a standard pipe wrench (not shown) is used to turn and twist the splice bar or rod or dowel rod 10, 20, into the opening 29, 39, of the coupler pipe 28, 38, which is very labor intensive, and a very tedious task to individually, and manually place, and then manually turn the rebar rod 10, 20, into the coupler pipe 28, 38, and then turn it enough times to secure the mating contact between the two, namely, the splice bar or rod 10, 20, and the corresponding coupler or flange coupler 25, 35, 125, via the coupler pipe 28, 38, for the flange coupler 25, 35. It should be appreciated that the end result using The Jimmy Twist 23, as shown in FIGS. 4, 5, and 7, 9-11, 13, and 14, are the same but without the additional aggravation, as one end of the rebar rod 10, 20, would be secured by the jaws or teeth or mouth 45, of the inventive pipe wrench 43, while the inventive stop 41, of The Jimmy Twist 23, 53, 73, 93, 103, 113, 133, 143, would securely hold the non-threading end 10A, 10B, 20A, 20B, and the inventive eyelet 42, 142, would provide stability to the rebar rod 10, 20, as it is being inserted into the hole or opening 29, 39, 139, and allowed to mate with the internal threads 29T, 39T, of the coupler pipe 28, 38, 125, of the coupler or flange coupler 25, 35. FIG. 3, shows a coupler or flange coupler 35, that has a coupler pipe 38, having a hole or opening 39, which is a through-hole 39, and has internal threads 39T, that are along the complete length of the coupler pipe 38, from the first or top end 39A, to the second or bottom end 39B. Thus, it should be appreciated that a second rod or bar 10, 20, can be secured or screwed into the back of the coupler 35, through the hole or opening 39, at the bottom end 39B, such that one would have a rod or rebar 10, 20, protruding out of the coupler 35, at the first end 39A, and a second rod or rebar 10, 20, protruding out of the coupler 35, at the second end 39B, as more clearly shown in FIG. 12.

FIG. 4, illustrates a first embodiment of the inventive tool or apparatus 23, namely, The Jimmy Twist 23. As one can see in FIG. 4, that The Jimmy Twist 23, has a turn shaft 40, with a top or first end 40A, and a second or bottom end 40B, and where at least one turn handle 46, is securely positioned at the first end 40A, and at least one inventive adjustable pipe wrench 43, having a mouth or jaws 45, is securely positioned at the second end 40B. The inventive adjustable pipe wrench 43, has a mouth or teeth or jaws 45, that are used to securely hold or catch a first or bottom end of the splice bar or rod or dowel rod 10, 20, while a second end of the splice bar or rod 10, 20, is securely held in place at the stop surface 41B, of the stop 41, along, and parallel to the shaft of the turn shaft 40. At least one rod eyelet 42, having a through hole or opening 42B, can also be provided along the shaft of the turn shaft 40, between the stop 41. and the inventive adjustable pipe wrench 43, and which eyelet 42, is used to securely hold the splice bar or rod 10, 20, in place, while the splice bar rod 10, 20, is being rotated into the threaded rebar coupler 25, 35. The standard threaded rebar or rods 10, 20, are normally about two (2) feet long to about four (4) feet long, and thus a worker or installer does not have to go down to their knee level or bend down to install a rebar or rod or dowel rod 10, 20, that is normally between about two (2) feet long to about four (4) feet long, as the Jimmy Twist 23, has a long enough turn shaft 40, and with a turn handle 46, at an arm's reach level so as to allow the worker or installer to easily install or rotate the rebar or rod 10, 20, without having to bend, or go down to their knee level. For some applications the stop 41, could be secured to the surface of the turn shaft 40, by at least one securing means 41A, such as, for example, a weld 41A. Similarly, the at least one eyelet 42, could be secured to the surface of the turn shaft 40, by at least one securing means 42A, such as, for example, a weld 42A. The adjustable pipe wrench 43, has adjustable means 44, that are used to open and close the wrench jaws 45. For some applications the inventive adjustable pipe wrench 43, could have a rough surface 47, or grooves 47, to prevent the rotation or slipping of the DBS bar or rod 10, 20, while being held by the adjustable jaws 45. The turn handle 46, shown in FIG. 4, could be of a round shape, an oval shape, an X-shape, a T-shape, a straight rod shape, and combinations thereof, to name a few, as more clearly shown in FIGS. 6, and 8, using different shapes, and cross-sections.

FIG. 5, illustrates a second embodiment of the inventive tool or apparatus 53, namely, The Jimmy Twist 53. The second embodiment of the inventive Jimmy Twist 53, is similar to the one illustrated in FIG. 4, however it is an adjustable tool or apparatus 53, and where the turn shaft 50, has at least one track 48, having a plurality of stops or notches 49, which allow for the adjustment of the stop 51, the rod eyelet 52, and the inventive pipe wrench 55, practically anywhere along the turn shaft 50, as the stop 51, the rod eyelet 52, and the inventive adjustable pipe wrench 55, can be slid up or down along the track 48, and once their position is determined the stop or notch 49, would hold the stop 51, the rod eyelet 52, and the inventive adjustable pipe wrench 55, in their adjusted place while the inventive adjustable tool or apparatus 53, is being used. FIG. 5, further shows that a rod or bar 10, 20, has been slid through the hole or opening 52B, in the eyelet 52, and is held at the upper or first end 20B, by the surface 51B, of the stop 51, while the jaws 56, of the inventive adjustable pipe wrench 55, securely, and tightly hold the second or lower end 20A, of the rod 20. The stop 51, has at least one adjusting means 51A, that allow the adjustment up and down the track 48, for the stop 51. Similarly, the eyelet 52, has at least one adjusting means 52A, that allow the adjustment up and down the track 48, for the eyelet 52.

FIG. 6, illustrates a third embodiment of the inventive tool or apparatus 23, 53, 73, 93, 103, 113, 133, 143, namely, The Jimmy Twist 23, 53, 73, 93, 103, 113, 133, 143, showing a top view of a variety of turn handles 46, that can be used with the inventive tool 23, 53, 73, 93, 103, 113, 133, 143, and where the turn handle 46, is selected from a group comprising a straight handle 46A, an oval handle 46B, a round handle 46C, a disc shaped handle 46C, an internal X-shape handle 46C, a cross-shaped handle 46D, and combinations thereof, to name a few. Additionally, the cross-sectional shape for the turn handles shown in FIG. 6, could be selected from a group comprising of a round shape, an oval shape, a triangular shape, a rectangular shape, a square shape, a multisided shape, a polygonal shape, an odd shape, and combinations thereof, to name a few, as more clearly shown in FIG. 8.

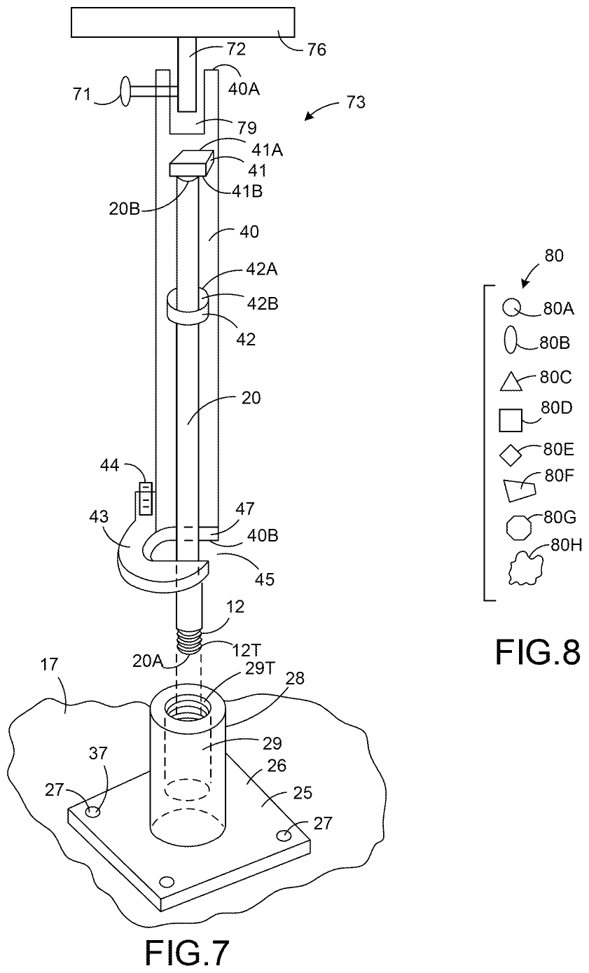

FIG. 7, illustrates a fourth embodiment of the inventive tool or apparatus 73, namely, The Jimmy Twist 73, as being used to install a rebar 10, 20, into a coupler or flange coupler 25, 35, 125, that has already been secured to a concrete 17, via a plurality of securing means 37, using the holes or openings 27. For some applications the coupler or flange coupler 25, 35, 125, is first secured to the concrete 17, and allowed to set. After the concrete 17, is set, and the coupler or flange coupler 25, 35, 125, is securely set in the concrete 17, the inventive tool 73, is used to secure the Dowel Bar Substitutes (DBS) or form savers 10, 20, having external threads 12T, 14T, into the opening 29, 39, having internal threads 29T, 39T, respectively. Preferably, the dowel bar 10, 20, is inserted through the mouth or jaws 45, of the inventive adjustable wrench 43, 55, is slid through the rod eyelet 42, 142, until the dowel bar end 10A, 10B, or 20B, has come to fully rest against the rod stop surface 41B, of the stop 41. Once the dowel rod 10, 20, has come to rest against the stop 41, the jaws 45, 56, of the inventive pipe wrench 43, 55, are tightened using pipe jaw adjusting means 44. For some applications the jaws 45, 56, could have a plurality of pipe gripping means 47, such as, for example, a rough surface 47, notches 47, undulations 47, and combinations thereof, to name a few. Thus, once the dowel bar 10, 20, is fully secured to the inventive tool 73, along or parallel to the turn shaft 40, of the inventive tool 73, the external threads 12T, 14T, are aligned with the internal threads 29T, 39T, of the coupler pipe 28, 38, 125, and the turn handle 46, is rotated, both in a circular motion, and longitudinal motion via pressure, so as to mate the external threads 12T, 14T, of the dowel bar rod 10, 20, with the internal threads 29T, 39T, of the coupler pipe 25, 35, 125, such that the dowel bar rod 10, 20, is securely mated with the coupler or flange coupler 25, 35, 125, and becomes a part of the coupler or flange coupler 25, 35, 125. Once the dowel bar rod 10, 20, has been fully secured to the coupler or flange coupler 25, 35, 125, the adjustable wrench adjusting means 44, of the adjustable wrench 43, are adjusted so as to release the grip of the mouth or jaws 45, 56, of the inventive adjustable wrench 43, 55, and allow for the removal or sliding out of the inventive tool 73, away from the dowel bar 10, 20. FIG. 7, further illustrates that the turn handle 76, can be adjusted as desired by the user or operator. The turn shaft 40, at the top or first end 40A, has at least one opening 79, for the insertion of at least one handle protrusion or male member 72, of the adjustable turn handle 76. At least one shaft securing means 71, such as, a screw 71, a tensioner 71, to name a few, can be used to secure the male member 72, within the hole or opening 79. For some applications the coupler 25, could be completely buried in concrete 17, as shown in FIG. 7, except for the opening or hole 29, having internal threads 29T.

FIG. 8, illustrates various cross-sectional shapes 80, that can be used for the various component of the inventive tool or apparatus 23, 53, 73, 93, 103, 113, 133, 143, namely, The Jimmy Twist 23, 53, 73, 93, 103, 113, 133, 143. The various cross-sectional shapes 80, could be selected from a group comprising a round or circular shape 80A, an oval shape 80B, a triangular shape 80C, a square shape 80D, a rectangular shape 80D, a diamond shape 80E, a tapered shape 80F, a trapezoid shape 80F, a polygonal shape 80G, an odd shape 80H, and combinations thereof, to name a few. For the ease of understanding the threaded rebar or dowel rod or splice bar 10, 20, have been shown as having a round cross-sectional area, however, the inventive tool or apparatus 23, 53, 73, 93, 103, 113, 133, 143, namely, The Jimmy Twist 23, 53, 73, 93, 103, 113, 133, 143, can be used with any of the cross-sectional shapes 80, as shown in FIG. 8. Similarly, for the ease of understanding the threaded rebar or dowel rod or splice bar 10, 20, have been shown as being substantially straight, however, the inventive tool or apparatus 23, 53, 73, 93, 103, 113, 133, 143, namely, The Jimmy Twist 23, 53, 73, 93, 103, 113, 133, 143, can be used with any shape for the threaded rebar or dowel rod or splice bar 10, 20, which are well known in the concrete construction industry, such as, for example, a U-shaped rod or splice bar 10, 20, an L-shaped rod or splice bar 10, 20, a bent rod or splice bar 10, 20, an angular rod or splice bar 10, 20, a tapered shaped rod or splice bar 10, 20, a diamond shaped rod or splice bar 10, 20, and combinations thereof, to name a few.

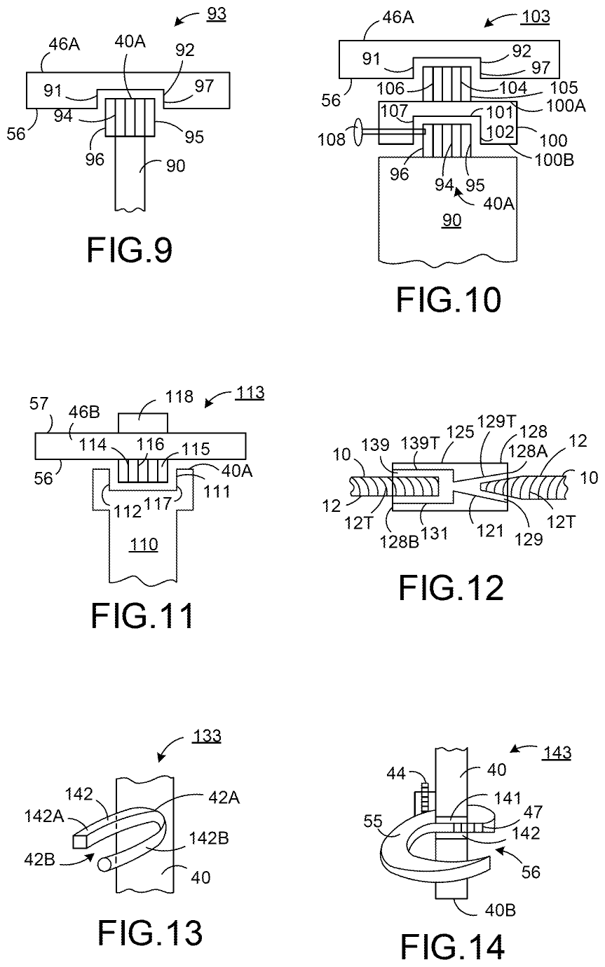

FIG. 9, illustrates a fifth embodiment of the inventive tool or apparatus 93, namely, The Jimmy Twist 93. The inventive tool 93, comprises of at least one handle 46A, which is similar to the handle 46, except that along the lower surface 56, the tool 93, has at least one drive handle channel or blind hole 91, having at least one wall engagement means 92, along the inner wall surface 97, of the blind hole or channel 91. The inventive tool 93, has a turn shaft 90, which is similar to the shaft 40, except that at the upper or first end 40A, the turn shaft 40, 90, has a drive head 95, having at least one drive engagement means 94, along the outer wall surface 96, of the drive head 95. For the ease of understanding the stop 41, the rod eyelet 42, the inventive adjustable pipe wrench 43, and other related components are not shown in FIG. 9. During use the user or operator places the turn handle 46A, over the turn shaft 90, such that, the drive head 95, goes inside and engages with the drive handle channel 91, and that the at least one wall engagement means 92, engages with the at least one drive engagement means 94, such that they form a single unit, or that when the turn handle 46A, is rotated or turned, the shaft 90, also correspondingly turns. The at least one wall engagement means 92, and at least one drive engagement means 94, could be selected from a group comprising notches, a male member, a female member, a tab, a protrusion, an angular wall, an angular surface, and combinations thereof, to name a few.

Pipe threaders are used to create custom lengths of threaded pipe, and can accommodate a range of pipe diameters. For some applications the pipe threader, could be for example, of an octagon shaped “puck” with a square or any shaped drive hole that slides over top of the matching male drive on The Jimmy Twist which would allow the pipe threader to work as needed.

FIG. 10, illustrates a sixth embodiment of the inventive tool or apparatus 103, namely, The Jimmy Twist 103. The inventive tool 103, comprises of at least one handle 46A, which is similar to the handle 46, except that along the lower surface 56, the tool 103, has at least one drive handle channel or blind hole 91, having at least one wall engagement means 92, along the inner wall surface 97, of the blind hole or channel 91. The inventive tool 103, has a shaft 90, which is similar to the shaft 40, except that at the upper or first end 40A, the shaft 40, has a drive head 95, having at least one drive engagement means 94, along the outer wall surface 96, of the drive head 95. For the ease of understanding the stop 41, the rod eyelet 42, the inventive adjustable pipe wrench 43, and other related components are not shown in FIG. 10. The inventive tool 103, has a head or drive adaptor 100, having male member or protrusion or drive head 105, at the first or upper surface 100A, and a female member or blind hole or channel 101, at the second or lower surface 100B. The male member or protrusion or drive head 105, has at least one drive engagement means 104, along the outer wall surface 106. The female member or blind hole or drive channel 101, has at least one drive engagement means 102, along the inner wall surface 107. During use the user or operator places the turn handle 46A, over the turn shaft 90, such that the drive adaptor 100, is in the middle, and that the drive head 95, goes inside and engages with the drive handle channel 101, and that the at least one wall engagement means 102, engages with the at least one drive engagement means 94. The next step is to place the drive handle 46A, and the adapter 100, assembly, over the turn shaft 90, such that the female member or blind hole or channel 101, engages with the drive head 95, while the at least one drive engagement means 102, along the inner wall surface 107, engage with the male member or protrusion or drive head 95. and that the at least one drive engagement means 102, engages with the at least one engaging means 94, of the male member or protrusion or drive head 95, such that they form a single unit, or that when the turn handle 46A, is rotated or turned, the turn shaft 90, also correspondingly turns. The at least one wall engagement means 92, 102, and at least one drive engagement means 94, 104, could be selected from a group comprising notches, a male member, a female member, a tab, a protrusion, an angular wall, an angular surface, and combinations thereof, to name a few. For some applications one could use at least one securing means 108, such as, a tensioner 108, a screw 108, an engaging means 108, and combinations thereof, to name a few, to hold the adapter 100, is secure engagement with the drive head 95, of the turn shaft 90.

FIG. 11, illustrates a seventh embodiment of the inventive tool or apparatus 113, namely, The Jimmy Twist 113. The inventive tool 113, comprises of at least one handle 46B, which is similar to the handle 46, except that along the lower surface 56, of the tool 113, has at least one drive socket or male member 115, having at least one wall engagement means 114, along an outer wall surface 116. The inventive tool 113, has a turn shaft 110, which is similar to the turn shaft 40, except that at the upper or first end 40A, the shaft 110, has a female member or blind hole or drive channel 111, having at least one drive engagement means 112, along the inner wall surface 117. The inventive handle 46B, on the top or first surface 57, has at least one drive ratchet or drive means 118, which when engaged, allows the handle 46A, to either go rotationally forward or rotationally backward, or clockwise or counterclockwise. It should be appreciated that a ratchet is a mechanical device that allows continuous linear or rotary motion in only one direction while preventing motion in the opposite direction. Ratchets are widely used in machinery and tools. The word ratchet is also used informally to refer to a ratcheting socket wrench. For the ease of understanding the stop 41, the rod eyelet 42, the inventive adjustable pipe wrench 43, and other related components are not shown in FIG. 11. During use the user or operator places the turn handle 46B, over the shaft 110, such that, the drive head or socket 115, goes inside and engages with the drive handle channel 111, and that the at least one wall engagement means 112, engages with the at least one drive engagement means 114, such that they form a single unit, or that when the turn handle 46B, is rotated or turned, the turn shaft 110, also correspondingly turns. The at least one wall engagement means 112, and at least one drive engagement means 114, could be selected from a group comprising notches, a male member, a female member, a tab, a protrusion, an angular wall, an angular surface, and combinations thereof, to name a few. The turn handle 46B, can also comprise of at least one ratcheting mechanism 115, 118, for less readjusting. The turn handle 46B, that is used for ratcheting can comprise of any shape, and material that is suitable for the job. For some applications a torque ratchet mechanism 115, 118, can also be used with the turn handle 46B.

FIG. 12, illustrates another embodiment of a coupler 125, that can be used with the inventive tool or apparatus 23, 53, 73, 93, 103, 113, 133, 143, namely, The Jimmy Twist 23, 53, 73, 93, 103, 113, 133, 143. The coupler 125, has a pipe 128, having a first pipe end 128A, and a second pipe end 128B. The first pipe end 128A, has a hole or opening 129, that has internal threads 129T, and having a taper 121. The second pipe end 128B, has a hole or opening 139, that has internal threads 139T, and is substantially straight 131. For some applications the hole 129, 139, could be a blind hole 129, 139, as more clearly shown in FIG. 2. For some applications the hole 129, 139, could be a through hole 129, 139, as more clearly shown in FIG. 3, and FIG. 12. As one can see that the coupler 125, is a straight coupler 125, however, for some applications the coupler 125, could have at least one flange 25, 35, as more clearly shown in FIGS. 2, 3, and 7.

FIG. 13, illustrates an eight embodiment of the inventive tool or apparatus 133, namely, The Jimmy Twist 133, illustrating another embodiment of an eyelet 142, that can be used with the inventive tool or apparatus 23, 53, 73, 93, 103, 113, 143, namely, The Jimmy Twist 23, 53, 73, 93, 103, 113, 143. The eyelet 142, is shaped in a U-type shape having a first leg 142A, and a second leg 142B, to accommodate the bar 10, 20, within its legs 142A, 142B. The eyelet 142, can be secured to the shaft 40, by at least one means 42A, such as, a weld 42A, a ratcheting means 42A, and combinations thereof, to name a few. The cross-sectional area of the legs 142A, 142 B, can be of any shape or size. For some applications the cross-sectional area for the legs 142A, 142B, could be selected from the shapes illustrated in FIG. 8.

FIG. 14, illustrates a ninth embodiment of the inventive tool or apparatus 143, namely, The Jimmy Twist 143, illustrating another embodiment of an inventive adjustable pipe wrench 55, that can be used with the inventive tool or apparatus, namely, The Jimmy Twist 23, 53, 73, 93, 103, 113, 133. For some applications at the bottom 40B, of the turn shaft 40, one could have at least one first or top or upper bracket 141, and/or at least one second or bottom or lower bracket 142, to securely attach the inventive adjustable pipe wrench 43, 55, to the turn shaft 40. For some applications, the inventive adjustable pipe wrench 43, 55, can be fixed onto the surface of the turn shaft 40, or bolted onto the surface of the turn shaft 40, or welded onto the surface of the turn shaft 40, to name a few ways of securing the inventive adjustable pipe wrench 43, 55, to the surface of the turn shaft 40. For some applications the inventive adjustable wrench 43, 55, can be secured to the turn shaft 40, by using nut and bolt, or any quick release system, such as, for example, a quick release bolt.

One could also use a device that would have any type of a turn handle which is suitable for task, and could easily slip over the DBS to be secured to the coupler. The pipe or cylinder would stabilize the DBS, while offering a smooth, and easy twist. The turn handle for the inventive Jimmy Twist could be fixed, or detachable or adjustable. The turn handle could also be fitted with a drive socket 115. This drive socket 115, would preferably be centered over, or “plumb”, over the top of the DBS or rebar. This will allow for a smooth turn when using drive socket with drill, ratchet wrench, or any apparatus designed to turn a socket drive. The drive socket fixture could include, but is not limited to, the traditional square design, but to any shape, and any size drive system. The inventive Jimmy Twist could also have an attachment that fits an electric pipe threader, a special die adapter for the bigger bars when other methods or tools are not available. It should be understood that the attachment are not limited to just fit electric pipe threader but all types of pipe threaders, manual or electric.

It should be appreciated that the dowel rod or rebar 10, 20, usually come in widths or diameter between about 3.175 mm (⅛ inches), to about 50.8 mm (2 inches), but they can be as wide as 304.8 mm (12 inches). The dowel rod or rebar 10, 20, are usually between about 304.8 mm (12 inches), to about 2.4 m (94.5 inches) long.

Dowel Bar Substitutes (DBS) or form savers 10, 20, provide continuity and structural integrity to reinforced concrete construction. Dowel Bar Substitutes (DBS) 10, 20, are a very efficient way to join rebar 10, 20, in segmental construction by using at least one coupler 25, 35, 125, to extend the reinforcement capabilities of the rebar 10, 20.

The cross-sectional area for the inventive tool shaft 40, could be be selected from a group comprising a triangular shape, a square shape, a rectangular shape, a circular shape, an oval shape, a polygonal shape, a cylindrical shape, and combinations thereof, to name a few, as more clearly shown in FIG. 8.

The inventive tool 23, 53, 73, 93, 103, 113, 133, 143, could be made from a material selected from a group comprising metal, stainless steel, aluminum, high strength polymeric material, composite material, and combinations thereof, to name a few.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An apparatus, comprising:
(a) a turn shaft having a first end, and a second end;
(b) a turn handle in secure, and engaging contact with said turn shaft at said first end;
(c) an adjustable pipe wrench in secure, and engaging contact with said turn shaft at said second end; and
(d) a stop in secure contact with said turn shaft between said first end, and said end.

2. The apparatus of claim 1, wherein at least one eyelet is in secure contact with said turn shaft between said adjustable pipe wrench, and said stop.

3. The apparatus of claim 1, wherein at least one eyelet is in secure contact with said turn shaft between said adjustable pipe wrench, and said stop, and wherein said eyelet has a central opening.

4. The apparatus of claim 1, wherein at least one eyelet is in secure contact with said turn shaft between said adjustable pipe wrench, and said stop, and wherein said eyelet is U-shaped, having a first leg and a second leg.

5. The apparatus of claim 1, wherein said adjustable pipe wrench has at least one means to adjust jaws of said adjustable pipe wrench.

6. The apparatus of claim 1, wherein said turn shaft has at least one track for adjusting positions of said adjustable pipe wrench, and said stop.

7. The apparatus of claim 1, wherein said first end of said turn handle has a female member to accommodate a male member of said turn handle.

8. The apparatus of claim 1 wherein said first end of said turn handle has a female member to accommodate a male member of said turn handle, and at least one securing means secures said female member of said turn shaft to the male member of said turn handle.

9. The apparatus of claim 1, wherein said first end of said turn handle has a female member to accommodate a male member of said turn handle, and wherein said female member has a plurality of undulation on its surface to engage with a plurality of undulations on the surface of said male member of said turn handle.

10. The apparatus of claim 1, wherein said turn handle has a shape, and wherein said shape is selected from a group consisting of a straight handle shape, an oval handle shape, a round handle shape, a disc shaped handle, an internal X-shape handle, a cross-shaped handle, and combinations thereof.

11. The apparatus of claim 1, wherein said turn handle has a cross-sectional shape, and wherein said cross-sectional shape is selected from a group consisting of a round shape, an oval shape, a triangular shape, a rectangular shape, a square shape, a multisided shape, a polygonal shape, an odd shape, and combinations thereof.

12. The apparatus of claim 1, wherein said turn shaft has at least one bracket to securely and engageably accommodate said adjustable wrench.

13. The apparatus of claim 1, wherein said turn shaft has a cross-sectional shape, and wherein said cross-sectional shape is selected from a group consisting of a round shape, an oval shape, a triangular shape, a rectangular shape, a square shape, a multisided shape, a polygonal shape, an odd shape, and combinations thereof.

14. The apparatus of claim 1, wherein said turn handle is made from a material selected from a group consisting of metal, stainless steel, aluminum, high strength polymeric material, composite material, and combinations thereof.

15. The apparatus of claim 1, wherein said turn shaft is made from a material selected from a group consisting of metal, stainless steel, aluminum, high strength polymeric material, composite material, and combinations thereof

16. The apparatus of claim 1 wherein said turn shaft has at least one bracket to securely accommodate said adjustable pipe wrench.

17. The apparatus of claim 1, wherein at least one adaptor is securely, and engageably placed between said handle and said turn shaft.

18. A method of securing a rod to a coupler, comprising the steps of:
(a) taking a turning tool, wherein said turning tool has a turn shaft having a first end, and a second end, and wherein said first end has a turn handle, and said second end has an adjustable pipe wrench, and a stop between said first end, and said end;
(b) taking a threaded rod having a first end and a second end, and removably engaging said first end against said stop on said turn shaft;
(c) removably securing a portion of said second end of said rod inside a jaw of said adjustable pipe wrench;
(d) engaging a threaded portion of said rod with a threaded opening in said coupler, and turning said turn handle to screw said threaded portion of said threaded rod into said threaded portion of said coupler.

19. The method of securing a rod to a coupler of claim 18, wherein said coupler has a flange,

20. The method of securing a rod to a coupler of claim 18, wherein said turn handle has at least one ratchet means to ratchetingly turn said turn shaft in one rotational direction at a time.
